(19) United States
(12) Patent Application Publication
(10) Pub. No.: US 2015/0279375 A1
(43) Pub. Date: Oct. 1, 2015

(54) Audio Multi-Code Transmission Method And Corresponding Apparatus

(71) Applicant: ZTE CORPORATION, Shenzhen, Guangdong (CN)

(72) Inventor: Lehui Bao, Shenzhen City (CN)

(73) Assignee: ZTE Corporation, Shenzhen City, Guangdong (CN)

(21) Appl. No.: 14/441,434

(22) PCT Filed: Aug. 28, 2013
(86) PCT No.: PCT/CN2013/082472

§ 371 Date: May 7, 2015

(30) Foreign Application Priority Data
Nov. 7, 2012 (CN) 201210440924.4

(51) Int. Cl. G10L 19/00

(52) U.S. Cl. CPC G10L 19/00

(57) ABSTRACT

Disclosed are an audio multi-code transmission method and a corresponding apparatus, wherein, the method includes: an encoding end generating a code identifier according to input multi-code parameter information, information data and audio data; generating enhanced data according to the input information data and/or audio data; or directly using the information data as the enhanced data; encoding the audio data input to the encoding end to generate audio encoded data; generating multi-code voice frames with the enhanced data according to the code identifier, the enhanced data and the audio encoded data, and packaging and sending the multi-code voice frames to an audio multi-code decoding end; the decoding end receiving the multi-code voice frames sent by the encoding end, parsing the multi-code voice frames to obtain the code identifier, encoded enhanced data and audio data; decoding the encoded enhanced data according to the code identifier; and decoding the encoded audio data.

### CROSS-REFERENCE TO RELATED APPLICATION(S)

This application is the U.S. National Phase application of PCT application number PCT/CN2013/082472 having a PCT filing date of Aug. 28, 2013, which claims priority of Chinese patent application 201210440924.4 filed on Nov. 7, 2012, the disclosures of which are hereby incorporated by reference.

### TECHNICAL FIELD

The present invention relates to the field of communication technology, and more particularly, to an audio multi-code transmission method and a corresponding apparatus.

### BACKGROUND OF THE RELATED ART

With the popularity of Internet, more and more medias (such as videos and audios) are transmitted over the IP network, VoIP (Voice over Internet Protocol) is a typical service based on the IP packet network multimedia, and uses the IP network or the Internet for voice transmission, and the main feature of this technology is to compress, encode, package, and then transmit the analog audio signal over the IP network in the form of data packets.

Real-time voice transmission generally uses the UDP to transmit voice data packets to improve real-time of the transmission, and the mechanism of the UDP is to transmit IP packets by means of best effort, and while it does not guarantee correctly transmitting the data packets to the destination, and the packet loss or delay may be caused due to network jitter, network congestion, and other reasons when the data packets are transmitted in the network, and the data packet loss directly degrades the voice quality, moreover the lost packets will also affect the decoding of the voice data which are received correctly subsequently, and the voice call will be significantly delayed or even interrupted, which seriously affects the user experience. For the IP packet loss, existing technology is using forward error correction (FEC) to recover the lost voice packets, however, the FEC technology increases the demand for bandwidth, and the lost voice packets need to be restored with operations with additional voice packets, which also increases the delay.

The IP network cannot provide high quality guarantee when transmitting a real-time communication media such as voice, compared with transmitting a text message, due to its own limitations. Therefore, how to extend the existing voice encoding and decoding capability, improve the service quality of high real-time media, and ensure the user experience of voice call, is a problem to be solved.

### SUMMARY OF THE INVENTION

In view of the abovementioned analysis, the present invention aims at providing an audio multi-code transmission method and a corresponding apparatus to solve the problem in the related art that the IP network cannot provide quality guarantee brought by its own limitations when transmitting a real-time communication media such as voice.

The object of the present invention is mainly achieved through the following technical scheme:

the present invention provides an audio multi-code encoding end, comprising:

an encoding control module, configured to: generate a code identifier according to input multi-code parameter information, information data and audio data, and send the code identifier to a multi-encoder, and send the information data and the audio data to an information encoding module or directly use the information data as enhanced data to send to the multi-encoder;

an information encoding module, configured to: comprise a plurality of information encoders, wherein the information encoders are configured to: generate enhanced data according to the input information data and/or audio data and send the enhanced data to the multi-encoder;

an audio encoder, configured to: encode the input audio data to generate audio encoded data and send the audio encoded data to the multi-encoder;

a multi-encoder, configured to: according to a received code identifier, enhanced data and audio encoded data, generate multi-code voice frames with the enhanced data, and package and send the multi-code voice frames to an audio multi-code decoding end.

Preferably, the encoding control module is configured to: develop an encoding policy according to the input multi-code parameter information as well as a type of the information data, and upon receiving the audio data, generate the code identifier according to the developed encoding policy; wherein the encoding policy comprises:

configuration of parameters related to the information encoder as well as configuration of parameters related to the multi-encoder.

Preferably, the code identifier is used to assist the information encoder and the multi-encoder in decoding, comprising: encoding-related information of data information, encoding information of the audio data, and encoding information of the enhanced data.

Preferably, the information data comprise one or more of decoding end feedback information, auxiliary information, enhanced information or value-added information.

Preferably, the multi-code voice frame comprises: a multi-code frame header and multi-code data, wherein the multi-code frame header is used to determine a frame header length, an audio data length and an information data length; the multi-code data comprise: audio data and enhanced data.

The present invention further provides an audio multi-code decoding end, comprising:

a multi-code parser, configured to: receive multi-code voice frames sent by an encoding end to parse, send a parsed-out code identifier and encoded enhanced data to an information decoding module, and send parsed-out encoded audio data to an audio decoder;

an information decoding module, configured to: comprise a plurality of information decoders, wherein the information decoders are configured to: decode the encoded enhanced data according to the code identifier, and send decoded information data out;

an audio decoder, configured to: decode the encoded audio data, and send the decoded audio data out.

The present invention further provides an audio multi-code encoding method, comprising:

an encoding end generating a code identifier according to input multi-code parameter information, information data, and audio data;

generating enhanced data according to the input information data and/or audio data; or directly using the information data as the enhanced data;

encoding the audio data input to the encoding end to generate audio encoded data;

according to the code identifier, the enhanced data and the audio encoded data, generating multi-code voice frames with enhanced data, and packaging and sending the multi-code voice frames to an audio multi-code decoding end.

Preferably, generating a code identifier comprises:

developing an encoding policy according to the input multi-code parameter information as well as a type of the information data, and upon receiving the audio data, generating the code identifier according to the developed encoding policy; wherein the encoding policy comprises:

configuration of parameters related to an information encoder as well as configuration of parameters related to a multi-encoder.

Preferably, the code identifier comprises: encoding-related information of data information, encoding information of the audio data, and encoding information of the enhanced data.

Preferably, the information data comprise one or more of decoding end feedback information, auxiliary information, enhanced information and value-added information.

The present invention further provides an audio multi-code decoding method, comprising:

a decoding end receiving multi-code voice frames sent by an encoding end to parse, and sending a parsed-out code identifier, encoded enhanced data as well as audio data out;

decoding the encoded enhanced data according to the code identifier, and sending decoded information data out;

decoding encoded audio data and sending the decoded audio data out.

The beneficial effects of the embodiment of the present invention are as follows:

the embodiment of the present invention extends the audio encoding and decoding method to improve the service quality and user experience of media transmission over the IP network.

Other features and advantages of the present invention will be set forth in the following description, and partially they become apparent from the description, or can be learned by practicing the present invention. The objectives and other advantages of the present invention may be implemented and obtained through the structure particularly pointed out in the written description, claims and accompanying drawings.

### BRIEF DESCRIPTION OF THE DRAWINGS

FIG. 1 is a schematic diagram of a structure of the encoding end in accordance with an embodiment of the present invention;

FIG. 2 is a schematic diagram of a composition structure of a multi-code voice frame in accordance with an embodiment of the present invention;

FIG. 3 is a schematic diagram of the structure of the decoding end in accordance with an embodiment of the present invention;

FIG. 4 is a schematic diagram of the process of the encoding method in accordance with an embodiment of the present invention;

FIG. 5 is a schematic diagram of the process of the decoding method in accordance with an embodiment of the present invention.

### PREFERRED EMBODIMENTS OF THE INVENTION

Hereinafter, in conjunction with the accompanying drawings, the preferred embodiments of the present invention will be specifically described, wherein, the accompanying drawings form a part of the present application, and serve to explain the principle of the present invention together with the embodiments of the present invention.

First, with reference to FIG. 1, the encoding end in accordance with an embodiment of the present invention will be described in detail.

As shown in FIG. 1, FIG. 1 is a schematic diagram of the structure of the encoding end in accordance with an embodiment of the present invention, specifically comprising:

an encoding control module, used to generate a code identifier according to input multi-code parameter information, information data and audio data, and send the code identifier to a multi-encoder, and send the information data and the audio data to an information encoding module or directly use the information data as enhanced data to send to the multi-encoder; specifically speaking, the encoding control module develops an encoding policy according to the input multi-code parameter information as well as the type of information data, and generates a code identifier according to the developed encoding policy upon receiving the audio data; wherein the encoding policy comprises: configuration of parameters related to the information encoder as well as configuration of parameters related to the multi-encoder;

an information encoding module, comprising a plurality of information encoders, wherein the information encoders are used to generate enhanced data according to the input information data and/or audio data and send the enhanced data to the multi-encoder;

an audio encoder, used to encode the input audio data to generate audio encoded data and send the audio encoded data to the multi-encoder;

a multi-encoder, used to generate multi-code voice frames with the enhanced data according to the received code identifier, enhanced data and audio encoded data, and package and send the multi-code voice frames to the audio multi-code decoding end.

The abovementioned code identifier is used to assist the information encoder and the multi-encoder in decoding, the code identifier can assist the information encoder and the multi-encoder in encoding and decoding. For example, the code identifier can comprise information encoding-related information (the type of the information encoder and parameters), voice segment encoding information (voice encoding type, sampling rate, voice encoded data length), and enhanced data encoding information (encoding method, enhanced data length). The code identifier length can be fixed or not isometric, if not isometric, it should have a field for the identifier length.

The abovementioned enhanced data can be directly related information input externally, or generated by processing the input voice data and the related information together or separately. For example, the externally-input text message directly works as the enhanced data, which causes the attention of the user at the receiving end after being parsed and prompts the user. Alternatively, voice recognition processing is performed on the input voice data to form voice captions or simultaneous translation subtitles, and to generate the enhanced data to help the receiving user understand the call content. The enhanced data may also be generated by processing the voice data and the related information together, for example, FEC processing can be performed on the voice data to generate redundant data of the voice data as the enhanced data, when an error occurs in the voice data, the enhanced data are used to recover, whereby guaranteeing the call quality. The enhanced data can also be call-associated information, such as, background information of something mentioned during the call. Meanwhile the enhanced data can also be value-added information, such as subtitle advertisement and other information.

The generation of enhanced information needs to be comprehensively considered. In the case that the channel resources are constraint, the enhanced information can selectively not to be sent. The needs of the decoding end are considered preferably, and according to the decoding feedback, the type of enhanced information is determined. The type of enhanced information can change dynamically during a call, for example, when the network is in good condition, the enhanced information can be changed from FEC data to caption information.

The abovementioned information data comprise one or more of decoding end feedback information, auxiliary information, enhanced information or value-added information. Specifically speaking, the abovementioned information data comprise the decoding end feedback information, and the feedback information comprises packet loss rate, jitter, bit rate and other information, when the information data comprise the decoding end feedback information, the encoding end should update the corresponding encoding parameters of the audio encoder and the information encoder to meet the feedback information, and generate a code identifier at the same time; when the information data further comprises auxiliary information recording an associated relationship with the voice call (the auxiliary information comprises statistical information of the voice frame data, text description of the voice frame data, some tips for the decoding end, or some text expression which can help the decoding end understand the call), the information encoding scheme should be that an auxiliary information encoder performs encoding to generate the enhanced data and also generate an auxiliary information code identifier at the same time; when the information data further comprise value-added information which has an associated relationship with the voice call (the value-added information comprises program associated information, or a detailed description of the information mentioned during the call), the information encoding scheme should be that a value-added information encoder performs encoding to generate the enhanced data and also generate a value-added information code identifier at the same time; when the input information data is enhanced information, the information encoding scheme should be that the enhanced information encoder performs encoding to generate enhanced data and also generate an enhanced information code identifier at the same time; and if the input information data is the value-added information, the input information data can also be directly used as enhanced data without being encoded by the information encoder.

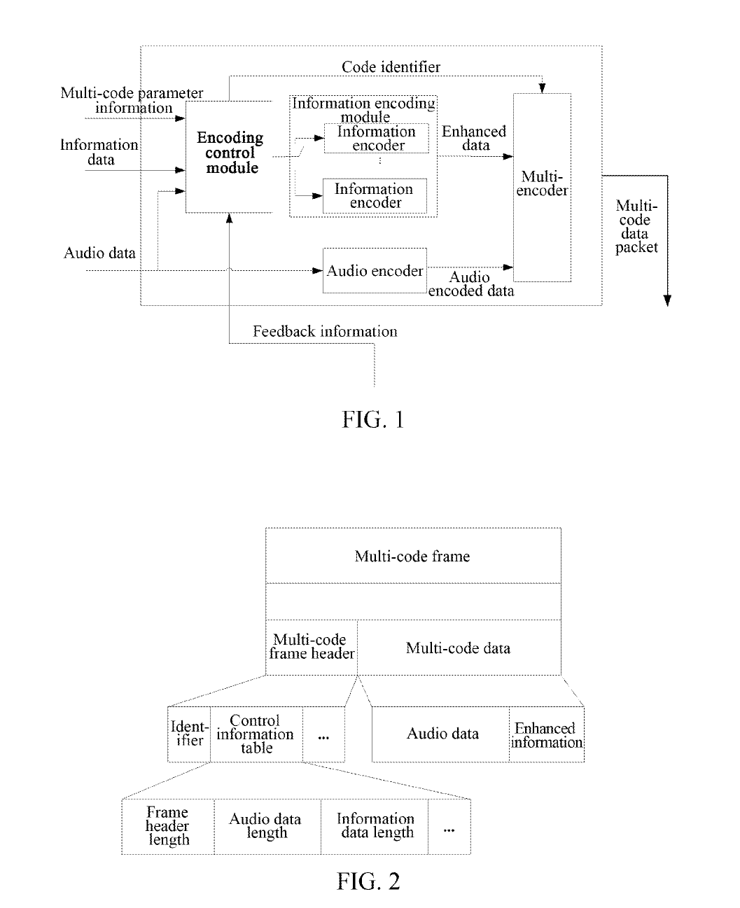

The composition structure of the abovementioned multi-code voice frame is shown in FIG. 2, specifically comprising: a multi-code frame header and multi-code data, wherein the multi-code frame header is used to determine the frame header length, the audio data length, and the information data length; the multi-code data comprise the audio data and the enhanced data.

As shown in FIG. 3, FIG. 3 is a schematic diagram of the structure of the decoding end in accordance with an embodiment of the present invention, specifically comprising:

a multi-code parser, used to receive multi-code voice frames sent by the encoding end to parse, and send the parsed-out code identifier and the encoded enhanced data to the information decoding module, and send the parsed-out encoded audio data to the audio decoder;

an information decoding module, comprising a plurality of information decoders, wherein the information decoders are used to decode the encoded enhanced data according to the code identifier, and send the decoded information data out;

an audio decoder, configured to: decode the encoded audio data, and send the decoded audio data out.

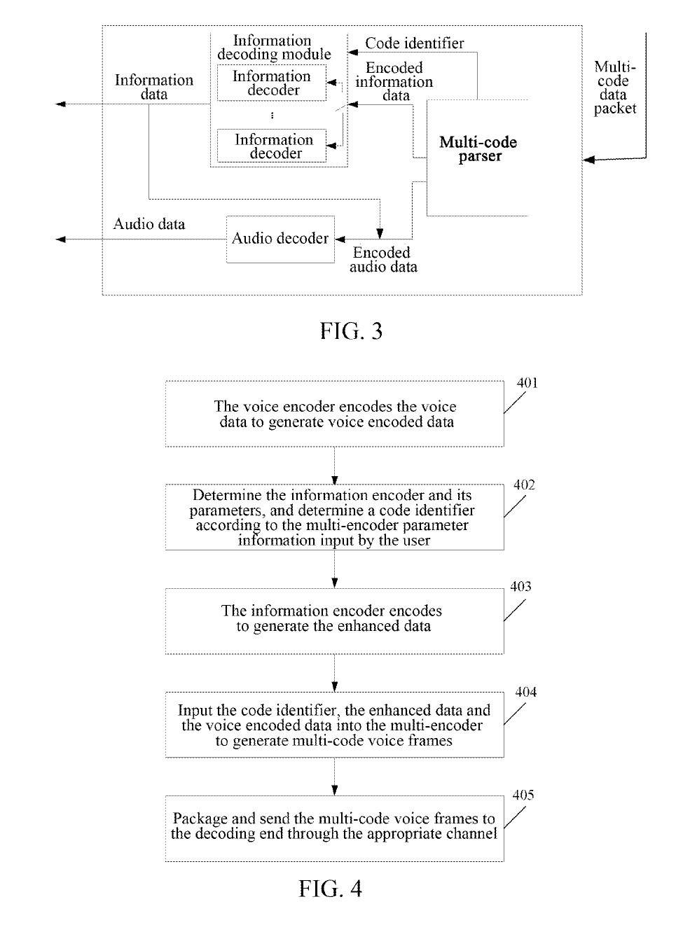

Hereinafter, the method in accordance with an embodiment of the present invention will be described in detail with combination of FIG. 4.

As shown in FIG. 4, FIG. 4 is a schematic diagram of the process of the encoding method in accordance with an embodiment of the present invention, specifically comprising:

in step 401, the input audio data are encoded with the audio encoder specified by the user to generate audio encoded data;

in step 402, it is to determine the type of the information encoder, configure related parameters, and generate a code identifier according to the multi-encoder parameter information input by the user;

in step 403, the information encoder generates the enhanced data by doing certain processing to the input audio data and related information;

in step 404, it is to input the code identifier, enhanced data and voice encoded data into the multi-encoder, and the multi-encoder generates multi-code voice frames with enhanced information according to the code identifier;

in step 405, it is to package and send the multi-code frames to the decoder through the appropriate channel.

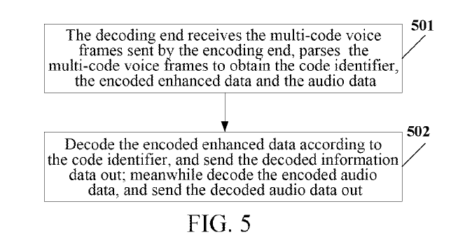

As shown in FIG. 5, FIG. 5 is a schematic diagram of the process of the decoding method in accordance with an embodiment of the present invention, specifically comprising:

in step 501, the decoding end receives the multi-code voice frames sent by the encoding end to parse, and send the parsed-out code identifier, the encoded enhanced data as well as the audio data out;

in step 502, it is to decode the encoded enhanced data according to the code identifier, and send the decoded information data out; meanwhile decode the encoded audio data, and send the decoded audio data out.

The above description is only for preferred specific embodiments of the present invention, but the protection scope of the present invention is not limited to this, any changes or replacements that can be easily thought by a person skilled in the art within the technical scope disclosed in the present invention should fall within the protection scope of the present invention. Accordingly, the protection scope of the present invention should be the protection scope of the claims.

### INDUSTRIAL APPLICABILITY

In summary, the embodiments of the present invention provide an audio multi-code transmission method and a corresponding apparatus, the user can input some related information which has a relationship with the voice call, and according to the encoding policy developed by the user, the information encoder generates enhanced data, or the related information is directly worked as enhanced data, on which multi-code operation is performed together with the voice encoded data encoded by the audio encoder, to form voice frames with the enhanced information. The voice frames are packaged and transmitted to the decoding end in the corresponding channel. In order to help the decoding end better understand the voice data sent by the encoding end, the multi-encoder can encode the auxiliary information and the voice data input by the user into voice frames to transmit. In the case that the network is abnormal, the decoding end can still help understand the meaning of the voice sent by the encoding end through the decoded auxiliary information. The present invention extends the audio encoding and decoding method to improve the service quality and user experience of media transmission over the IP network.

1. An audio multi-code encoding end, comprising:
an encoding control module, configured to: generate a code identifier according to input multi-code parameter information, information data and audio data, and send the code identifier to a multi-encoder, and send the information data and the audio data to an information encoding module or directly use the information data as enhanced data to send to the multi-encoder;
an information encoding module, configured to: comprise a plurality of information encoders, wherein the information encoders are configured to: generate enhanced data according to the input information data and/or audio data and send the enhanced data to the multi-encoder;
an audio encoder, configured to: encode the input audio data to generate audio encoded data and send the audio encoded data to the multi-encoder;
a multi-encoder, configured to: according to a received code identifier, enhanced data and audio encoded data, generate multi-code voice frames with the enhanced data, and package and send the multi-code voice frames to an audio multi-code decoding end.

2. The encoding end of claim 1, wherein, the encoding control module is configured to: develop an encoding policy according to the input multi-code parameter information as well as a type of the information data, and upon receiving the audio data, generate the code identifier according to the developed encoding policy; wherein the encoding policy comprises: configuration of parameters related to the information encoder as well as configuration of parameters related to the multi-encoder.

3. The encoding end of claim 1, wherein, the code identifier is used to assist the information encoder and the multi-encoder in decoding, comprising: encoding-related information of data information, encoding information of the audio data, and encoding information of the enhanced data.

4. The encoding end of claim 1, wherein, the information data comprise one or more of decoding end feedback information, auxiliary information, enhanced information or value-added information.

5. The encoding end of claim 1, wherein, the multi-code voice frame comprises: a multi-code frame header and multi-code data, wherein the multi-code frame header is used to determine a frame header length, an audio data length and an information data length; the multi-code data comprise: audio data and enhanced data.

6. An audio multi-code decoding end, comprising:
a multi-code parser, configured to: receive multi-code voice frames sent by an encoding end to parse, send a parsed-out code identifier and encoded enhanced data to an information decoding module, and send parsed-out encoded audio data to an audio decoder;
an information decoding module, configured to: comprise a plurality of information decoders, wherein the information decoders are configured to: decode the encoded enhanced data according to the code identifier, and send decoded information data out;
an audio decoder, configured to: decode the encoded audio data, and send the decoded audio data out.

7. An audio multi-code encoding method, comprising:
an encoding end generating a code identifier according to input multi-code parameter information, information data, and audio data;
generating enhanced data according to the input information data and/or audio data; or directly using the information data as the enhanced data;
encoding the audio data input to the encoding end to generate audio encoded data;
according to the code identifier, the enhanced data and the audio encoded data, generating multi-code voice frames with enhanced data, and packaging and sending the multi-code voice frames to an audio multi-code decoding end.

8. The encoding method of claim 7, wherein, generating a code identifier comprises:
developing an encoding policy according to the input multi-code parameter information as well as a type of the information data, and upon receiving the audio data, generating the code identifier according to the developed encoding policy; wherein the encoding policy comprises:
configuration of parameters related to an information encoder as well as configuration of parameters related to a multi-encoder.

9. The encoding method of claim 7, wherein, the code identifier comprises: encoding-related information of data information, encoding information of the audio data, and encoding information of the enhanced data.

10. The encoding method of claim 7, wherein, the information data comprise one or more of decoding end feedback information, auxiliary information, enhanced information and value-added information.

11. An audio multi-code decoding method, comprising:
a decoding end receiving multi-code voice frames sent by an encoding end, parsing the multi-code voice frames to obtain the code identifier, encoded enhanced data and audio data;
decoding the encoded enhanced data according to the code identifier, and sending decoded information data out;
decoding encoded audio data and sending the decoded audio data out.

12. The encoding method of claim 8, wherein, the code identifier comprises: encoding-related information of data information, encoding information of the audio data, and encoding information of the enhanced data.

13. The encoding method of claim 8, wherein, the information data comprise one or more of decoding end feedback information, auxiliary information, enhanced information and value-added information.
